(19) United States
(12) Patent Application Publication
(10) Pub. No.: US 2009/0229687 A1
(43) Pub. Date: Sep. 17, 2009

(54) MARKER FOR FAUCET HANDLE

(75) Inventors: David Messner, Newbury, OH (US); Michael Meyer, Sagamore Hills, OH (US)

Correspondence Address: Fay Sharpe LLP, 1228 Euclid Avenue, 5th Floor, The Halle Building, Cleveland, OH, 44115, US

(73) Assignee: The Meyer Company

(21) Appl. No.: 12/404,653

(22) Filed: Mar. 16, 2009

Related U.S. Application Data
(60) Provisional application No. 61/037,098, filed on Mar. 17, 2008.
(60) Provisional application No. 61/037,098, filed on Mar. 17, 2008.

(51) Int. Cl. B67D 5/37

(52) U.S. Cl. 137/560; 137/801

(57) ABSTRACT

A marker for a faucet is provided to indicate information about the liquid or other flowable product to be dispensed from the faucet. The faucet, itself, includes a body and a handle operatively connected to the body for controlling flow of liquid through the body. The handle includes a base, first and second legs that project outwardly from the base, and a cross-bar that interconnects the legs at a location spaced from the base. The first and second legs and the cross-bar at least partially define an opening. The marker includes a body that is removably secured in the opening of the handle. The body of the marker includes indicia that provides information to a user of the faucet. The body is a resilient polymeric structure. Alternatively, the marker includes a handle engagement hook and a display region that includes indicia. The engagement hook is adapted to be engaged with the cross-bar of the faucet handle.

### CROSS-REFERENCE TO RELATED APPLICATION

This application claims priority from and benefit of the filing date of U.S. provisional application Ser. No. 61/037,098 filed Mar. 17, 2008, and the entire disclosure of said provisional application Ser. No. 61/037,098 is hereby expressly incorporated by reference into this specification.

### BACKGROUND

FIG. 1 illustrates a known faucet F for dispensing coffee, iced tea, water, or another liquid or flowable product from a container or urn U or other source. The faucet F includes a body B defining a flow path and contains a valve element for selectively blocking or unblocking the flow path. A bonnet N is secured to the body and captures the valve element therein. A handle H is operatively connected to the valve element by a stem that extends through the bonnet N. The handle H is adapted for being moved by a user to control the position of the valve element. In particular, pivoting movement of the handle H on an arc A causes a cam portion 22 of the handle H to bear against the bonnet N which, in turn, causes the handle H to pull on the stem that is connected to the valve element, thus unseating the valve element inside the body B. The valve element is typically spring-biased to its seated position, which corresponds to the illustrated position of the handle H.

The handle H comprises a generally wishbone shape including: (i) a base 20 comprising the cam portion 22 including cam surfaces 22a,22b; (ii) first and second legs 24a,24b that diverge as they move outwardly away from the base 20; and, (iii) a cross-bar 26 that extends between and interconnects the distal or outermost ends of the legs 24a,24b at a location spaced from the base 20. As such, the handle defines an opening 30 framed at least partially by the legs 24a,24b and cross-bar 26.

It is often desired to provide information to users of the faucet F as to the contents of the urn U or other source. Such information might include, e.g., “Regular Coffee,” “Decaffeinated Coffee,” “Hot Water,” “Iced Tea,” etc. Prior designs utilize a marker tag or sign that is suspended on a chain that is hung on the faucet body. According to the present development, a new marker for a faucet handle is provided.

### SUMMARY

In accordance with one aspect of the present development, a faucet includes a body and a handle operatively connected to the body for controlling flow of liquid through the body. The handle includes a base, first and second legs that project outwardly from the base, and a cross-bar that interconnects the legs at a location spaced from the base. The first and second legs and the cross-bar at least partially define an opening. A marker includes a body removably secured in the opening of the handle. The body includes indicia that provides information to a user of the faucet.

In accordance with another aspect of the present development, a marker for a faucet handle includes a polymeric body adapted to be removably secured in an opening of an associated faucet handle. The body includes indicia that provides information to a user of the associated faucet.

In accordance with another aspect of the present development, a marker for a faucet handle includes one-piece molded polymeric structure including a handle engagement hook adapted to be engaged with a cross-bar of an associated faucet handle. The hook defines a channel. At least one nib projects into the channel and is adapted to engage the cross-bar with a snap-fit. The marker further includes a display region extending from the handle engagement hook. The display region includes indicia that provides information to a user.

### BRIEF DESCRIPTION OF DRAWINGS

FIG. 1 (prior art) illustrates a known faucet including a handle for controlling the flow of liquid through the faucet;

FIG. 2A shows the known faucet handle H of FIG. 1 including a marker formed in accordance with one embodiment of the present development;

FIG. 2B shows the marker of FIG. 2A by itself;

FIG. 2C is a partial side view of the marker of FIG. 2B;

FIG. 3A shows the known faucet handle of FIG. 1 including an alternative marker formed in accordance with another embodiment of the present development;

FIG. 3B shows the marker of FIG. 3A by itself (with the indicia card omitted);

FIG. 4A shows the known faucet handle of FIG. 1 including a marker formed in accordance with another embodiment of the present development;

FIG. 4B shows the marker of FIG. 4A;

FIG. 5A shows the known faucet handle of FIG. 1 including a marker formed in accordance with another embodiment of the present development;

FIG. 5B shows the marker of FIG. 5A.

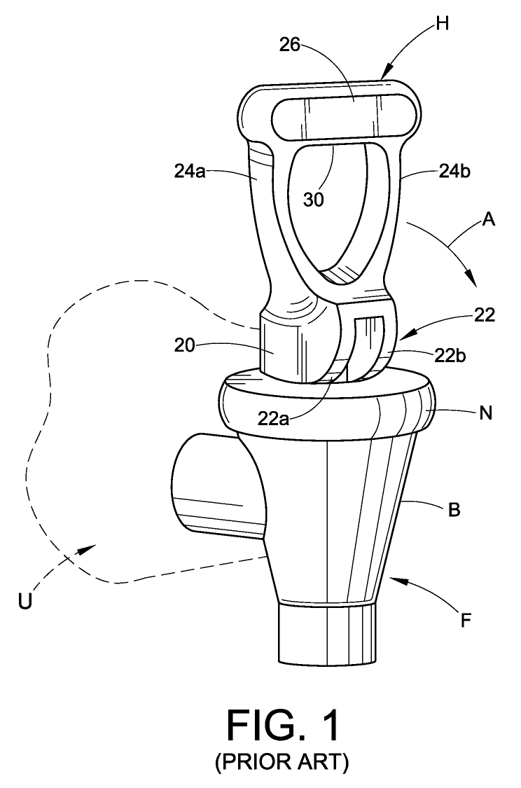

### DETAILED DESCRIPTION

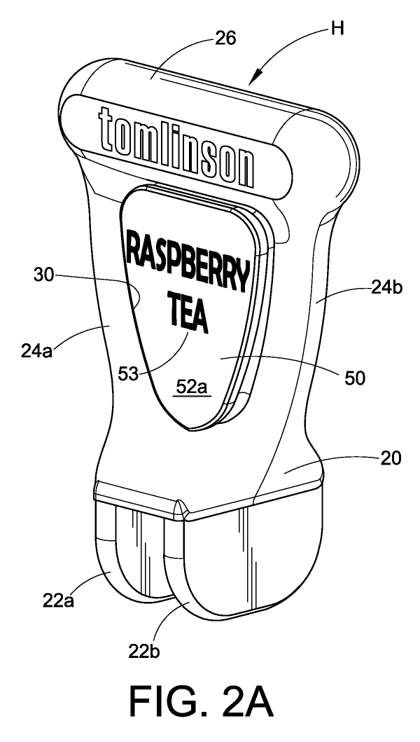

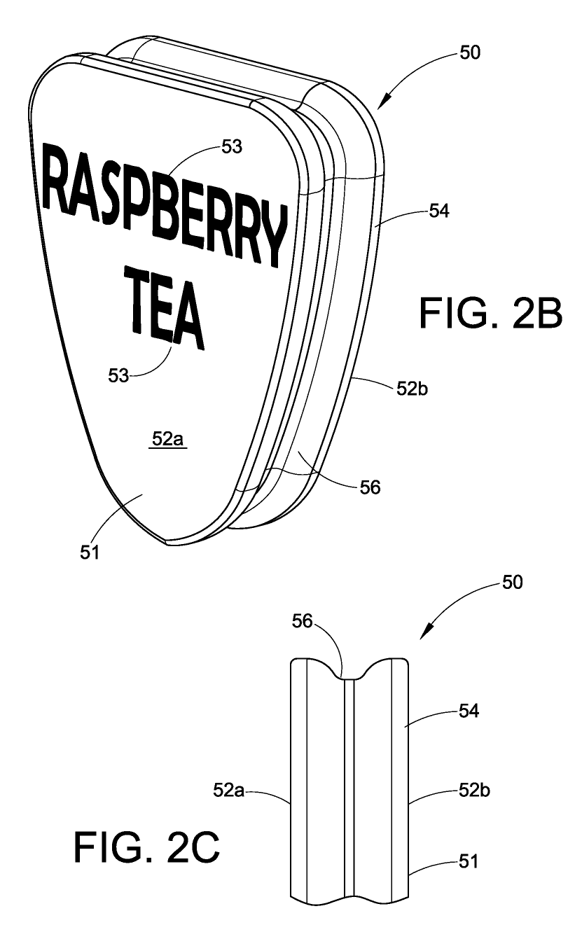

FIG. 2A shows the known faucet handle H including a marker 50 formed in accordance with one embodiment of the present development. The marker 50, itself, is shown in FIG. 2B. FIG. 2C is a partial side view of the marker 50. With reference to all of FIGS. 2A, 2B, 2C, the marker 50 includes a body 51 including opposite front and rear faces 52a,52b and a peripheral edge 54 that extends between and interconnects the front and rear faces 52a,52b. In the illustrated embodiment, the front and rear faces 52a,52b are parallel and spaced-apart relative to each other. The marker 50 is preferably defined from a resilient polymeric material, e.g., silicone, EPDM, or TPE, or another suitable material. The peripheral edge 54 is conformed and dimensioned to correspond with the size and shape of the handle opening 30, so as to be tightly received in the handle opening 30 with a friction fit as shown in FIG. 2A, even accounting for minor variations in the size and shape of the handle opening 30 from one handle H to the next. For added holding strength and positioning alignment, the peripheral edge 54 of the marker 50 preferably includes a continuous groove 56 defined therein that is adapted to receive the legs 24a,24b and the cross-bar 26 of the handle H when the marker 50 is operatively installed as shown in FIG. 2A. In the illustrated embodiment, the groove 56 extends in the edge 54 continuously around the entire periphery of the body 51 to maximize engagement between the handle H and the groove 56. As such, the groove 56 mates with the legs 24a,24b and the cross-bar 26 of the handle H such that the marker 50 is more resistant to becoming dislodged from the opening 30. Preferably, there is no space or the minimum possible space between the peripheral edge 54 of the marker 50 and the faucet handle H to maximize the engagement between the marker 50 and handle H. Accordingly, the marker 50 is resistant to separation from the handle H under normal use conditions for a faucet F. The resilient fit between the marker 50 and handle H allows for easy but secure installation of the marker 50 to the handle H, and also allows the marker 50 to be removed as desired.

At least the front face 52a or both the front and rear faces 52a,52b include indicia 53 that provide information as to the contents of an urn U or other container/source to which a faucet F including the handle 50 is connected, e.g., the indicia 53 can read “Raspberry Tea” (as shown in FIGS. 2A and 2B), “Iced Tea” “Coffee” “Decaf” etc. The indicia 53 can be printed indicia such as text or symbols as shown in FIGS. 2A and 2B, or the indicia can be embossed indicia, an adhesive label, or any other suitable indicia to convey the required information as to the product being dispensed. The color of the marker 50 can, itself, provide such indicia, e.g., providing a marker 50 with at least one orange face 52a,52b to indicate decaffeinated coffee. The front and rear faces 52a,52b can have the same indicia provided on or as part thereof, or different indicia can be provided on or as part of the front and rear faces 52a,52b to allow the displayed indicia to be varied depending upon whether the front face 52a or rear face 52b of the marker is oriented outward so as to be visible to users of the handle H. In one example, the front face 52a can read “REGULAR” and the rear face 52b can read “DECAF.”

Purchasers of the faucet F including the handle H can purchase or otherwise receive multiple different markers 50 and use them as deemed necessary and appropriate to provide the required information to users of the faucet F.

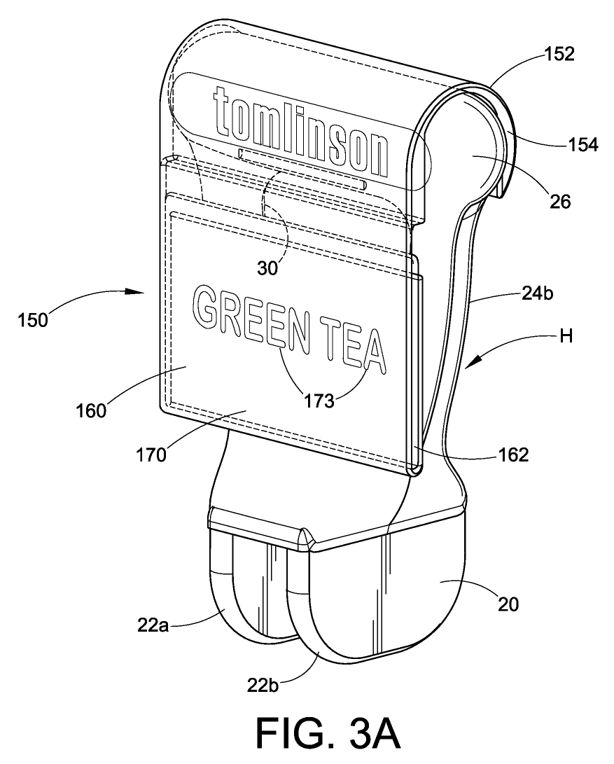

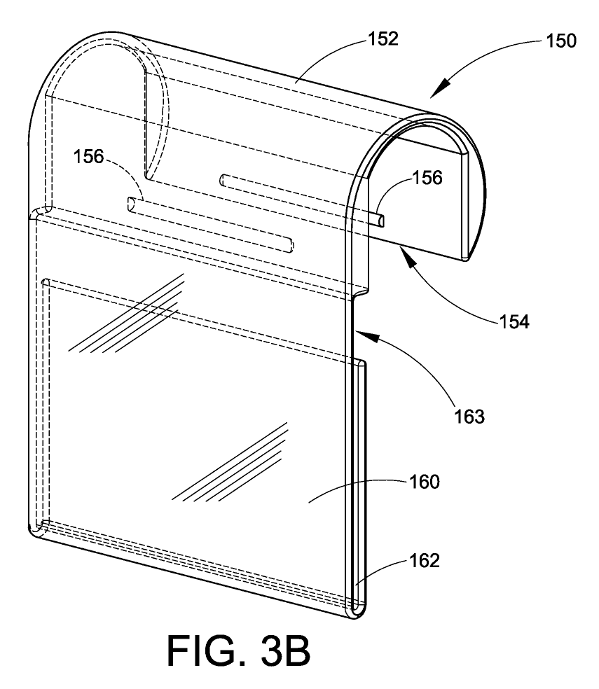

FIG. 3A shows the known faucet handle H including an alternative marker 150 formed in accordance with another embodiment of the present development. The marker 150 is shown by itself in FIG. 3B. Referring to FIGS. 3A and 3B, the marker 150 is defined as a molded or otherwise formed polymeric member, preferably one-piece. The marker 150 includes a handle engagement hook 152 that includes a channel 154 in which the handle cross-bar 26 is received with a close sliding fit. The channel 154 includes at least one and preferably first and second opposed nibs 156 that project toward each other into the channel 154. These nibs 156 are adapted to engage around the handle cross-bar 26 with a snap-fit when the cross-bar 26 is fully received in the channel 154 of the marker 150. The nibs 156 also can be sized to project a sufficient amount so that, upon lateral movement of the marker 150 along the longitudinal axis of the handle cross-bar 26, the nibs 156 contact the handle legs 24a,24b and prevent or at least inhibit further lateral movement of the marker 150 as would allow the handle cross-bar 26 to slide from the marker channel 154. The marker 150 also includes a display region 160 that is connected to the handle engagement hook 152 and that is adapted to lie in front of and adjacent to the handle legs 24a,24b when the marker 150 is installed as shown in FIG. 2A, such that the display region 160 substantially or completely covers the handle opening 30. The display region 160 can include indicia (such as the indicia 53 noted above) printed or otherwise included thereon for providing information as to the product being dispensed. In the illustrated embodiment, the display region 160 includes a slot or other region 162 adapted to removably receive an indicia card 170 made from paper or a polymeric or other material. The card 170 includes printed or other indicia 173 that functions to same as the indicia 53 referenced above. Again, the indicia 173 can merely be the color of the card 170. Multiple cards 170 including different indicia are provided, and the appropriate card 170 is installed in the slot 162 to reflect the liquid or other flowable product being dispensed by the faucet on which the handle H is installed. To allow for user viewing of the indicia card 170, the display region 160 is preferably defined from polymer that is transparent, i.e., transparent enough to allow the indicia 173 to be discerned by a user. Alternatively, the display region can include an opening or window to allow viewing of the card indicia 173. In the illustrated embodiment, the marker 150 is defined as a one-piece molded polymeric construction using a transparent polymer. The indicia cards 170 are dimensioned relative to the slot 162 so that a portion of each card 170 projects into an open card-removal region 163 (FIG. 3B) adjacent the slot 160 to facilitate manual removal of the card 170 from the slot.

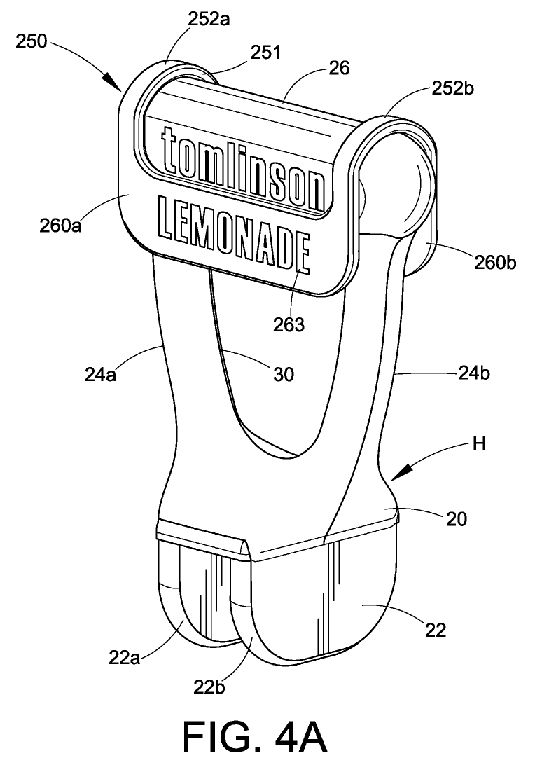

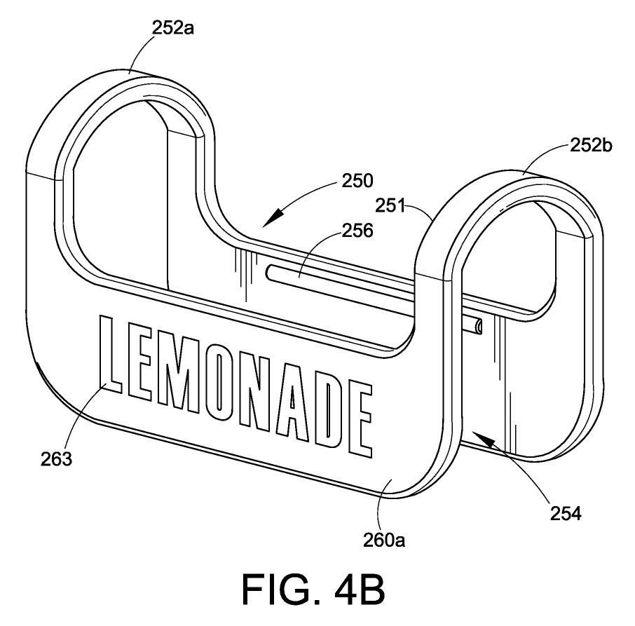

FIG. 4A shows the known faucet handle H including another alternative marker 250 formed in accordance with another embodiment of the present development. The marker 250 is shown by itself in FIG. 4B. Referring to FIGS. 4A and 4B, the marker 250 is defined as a molded or otherwise formed polymeric member, preferably one-piece. The marker 250 includes spaced-apart handle engagement hooks 252a,252b that cooperate to define a channel 254 in which the handle cross-bar 26 is received with a close sliding fit. Handle cross-bar 26 is at least partially visible between the hooks 252a,252b through an opening 251 defined between hooks 252a,252b. The channel 254 includes at least one and preferably first and second opposed nibs 256 that project toward each other into the channel 254. These nibs 256 are adapted to engage the handle cross-bar 26 with a snap-fit when the cross-bar 26 is fully received in the channel 254. The marker 250 includes at least a front display region or wall 260a and, preferably, front and rear display regions or walls 260a,260b that are connected to the handle engagement hooks 252a,252b and that lie adjacent and in front of and behind, respectively, the handle H. The front and rear display walls 260a,260b include printed or other indicia 263 to indicate what will be dispensed by a faucet to which the handle H is connected or other information, e.g., “Caution Hot.” The indicia 263 of the front 260a and rear 260b display walls can be the same or different as compared to each other and, if different, the marker 250 can be installed on the handle with one or the other display walls 260a,260b facing outward toward users as desired depending upon the product being dispensed.

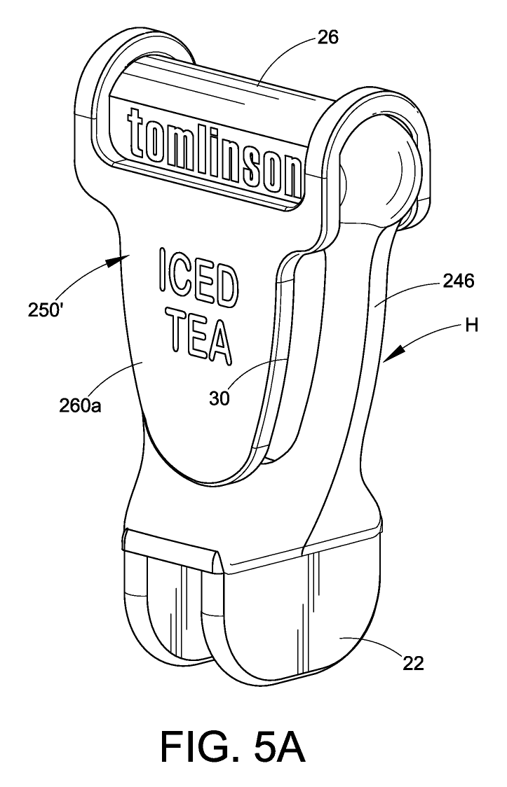

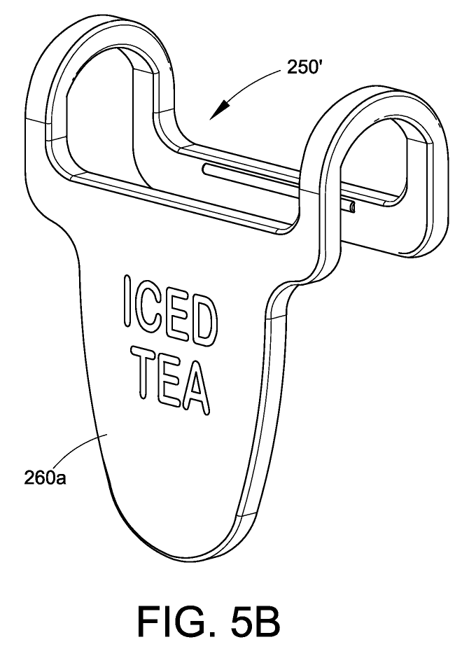

FIGS. 5A and 5B show another version of the marker 250 (labeled as 250′), in which the rear display wall 260b is omitted, and in which the front display wall 260a is shaped and dimensioned to correspond to the size and shape of the handle opening 30 so as to at least substantially overly same. The marker 250′ optionally includes a rear display wall shaped identically to the front display wall 260a.

The invention has been described with reference to preferred embodiments. It is intended that the invention be construed as encompassing modifications and alterations that will be apparent to those of ordinary skill in the art after reading this specification.

1. A faucet comprising:
a body;
a handle operatively connected to said body for controlling flow of liquid through the body, said handle comprising a base, first and second legs that project outwardly from the base, and a cross-bar that interconnects the legs at a location spaced from the base, said first and second legs and said cross-bar at least partially defining an opening;
a marker comprising a body removably secured in said opening of said handle, said body comprising indicia that provides information to a user of the faucet.

2. The faucet as set forth in claim 1, wherein said body comprises a peripheral edge that defines said body to have a shape that matches a shape of said opening.

3. The faucet as set forth in claim 2, wherein said peripheral edge includes a groove defined therein, and wherein said first and second legs are seated in said groove.

4. The faucet as set forth in claim 3, wherein said cross-bar is seated in said groove.

5. The faucet as set forth in claim 4, wherein said groove extends continuously and completely around said body.

6. The faucet as set forth in claim 3, wherein said body comprises first and second parallel spaced-apart faces, wherein said peripheral edge extends between and interconnects the first and second faces.

7. The faucet as set forth in claim 1, wherein said indicia comprises color.

8. The faucet as set forth in claim 1, wherein said body comprises opposite front and rear faces and wherein said indicia comprises text included on one or both of said front and rear faces.

9. The faucet as set forth in claim 1, wherein said body comprises opposite front and rear faces and wherein said body comprises indicia on both said front and rear faces, said indicia on said front face being different than said indicia on said rear face.

10. The faucet as set forth in claim 1, wherein said body is defined as a one-piece molded polymeric construction.

11. A marker for a faucet handle, said marker comprising:
a polymeric body adapted to be removably secured in an opening of an associated faucet handle, said body comprising indicia that provides information to a user of the associated faucet.

12. The marker as set forth in claim 11, wherein said polymeric body comprises a peripheral edge that defines said body to have a shape that matches a shape of said opening.

13. The marker as set forth in claim 12, wherein said peripheral edge includes a groove defined therein, and wherein said first and second legs are seated in said groove.

14. The marker as set forth in claim 13, wherein said cross-bar is seated in said groove.

15. The marker as set forth in claim 14, wherein said groove extends continuously and completely around said body.

16. The marker as set forth in claim 13, wherein said body comprises first and second parallel spaced-apart faces, wherein said peripheral edge extends between and interconnects the first and second faces.

17. The marker as set forth in claim 11, wherein said indicia comprises color.

18. The marker as set forth in claim 11, wherein said body comprises opposite front and rear faces and wherein said indicia comprises text included on one or both of said front and rear faces.

19. The marker as set forth in claim 18, wherein both said front and rear faces of said marker include indicia, wherein the indicia on the front face is different than the indicia on the rear face.

20. A marker for a faucet handle, said marker comprising:
a one-piece molded polymeric structure including:
a handle engagement hook adapted to by engaged with a cross-bar of an associated faucet handle, said hook defining a channel;
at least one nib that projects into the channel, said at least one nib adapted to engage the cross-bar with a snap-fit; and,
a display region extending from the handle engagement hook, said display region comprising indicia that provides information to a user.

21. The marker as set forth in claim 20, wherein said polymeric structure is transparent and said display region comprises a slot adapted to receive a card including said indicia.

22. The marker as set forth in claim 20, wherein said indicia comprises at least one of color and text.
